(19) United States
(12) Patent Application Publication
(10) Pub. No.: US 2011/0310008 A1
(43) Pub. Date: Dec. 22, 2011

(54) CURSOR CONTROL SYSTEM, CURSOR CONTROL METHOD THEREOF, AND ELECTRONIC DEVICE WITH CURSOR CONTROL FUNCTION

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/949,811

(22) Filed: Nov. 19, 2010

(30) Foreign Application Priority Data
Jun. 22, 2010 (TW) 99120168

(51) Int. Cl. G06F 3/033

(52) U.S. Cl. 345/157

(57) ABSTRACT

A cursor control method is applied in an electronic device that communicates with a number of pointing devices. The cursor control method includes: receiving a signal including an identification code; determining whether the received signal is a request signal; determining whether a duration of not receiving a cursor control signal from the pointing device which currently owns cursor control reaches a predetermined time interval after receiving the request signal; determining the pointing device which sends the request signal according to the identification code; transferring the cursor control to the determined pointing device if the duration reaches the predetermined time interval; and controlling movement of the displayed cursor according to a cursor control signal from the pointing device which currently owns the cursor control. A related cursor control system and a related electronic device are also provided.

### BACKGROUND

1. Technical Field

The present disclosure relates to cursor control systems and, particularly, to a cursor control system with a number of pointing devices for controlling a displayed cursor, a cursor control method thereof, and an electronic device with cursor function.

2. Description of Related Art

There are many kinds of collaborative activities, where multiple users would like to have a possibility to use simultaneously multiple pointing devices coupled to a shared computer to control multiple cursors displayed on the same display unit, where each pointing device controls a corresponding cursor. Multiple cursors displayed on the same display unit may confuse users, because the user may not know which cursor is associated with his/her own pointing device.

### BRIEF DESCRIPTION OF THE DRAWINGS

The components of the drawings are not necessarily drawn to scale, the emphasis instead being placed upon clearly illustrating the principles of a cursor control system, a cursor control method, and an electronic device with cursor function. Moreover, in the drawings, like reference numerals designate corresponding parts throughout several views.

FIG. 1 is a block diagram of a cursor control system in accordance with an exemplary embodiment.

FIG. 2 is a flowchart of a cursor control method in accordance with an exemplary embodiment.

### DETAILED DESCRIPTION

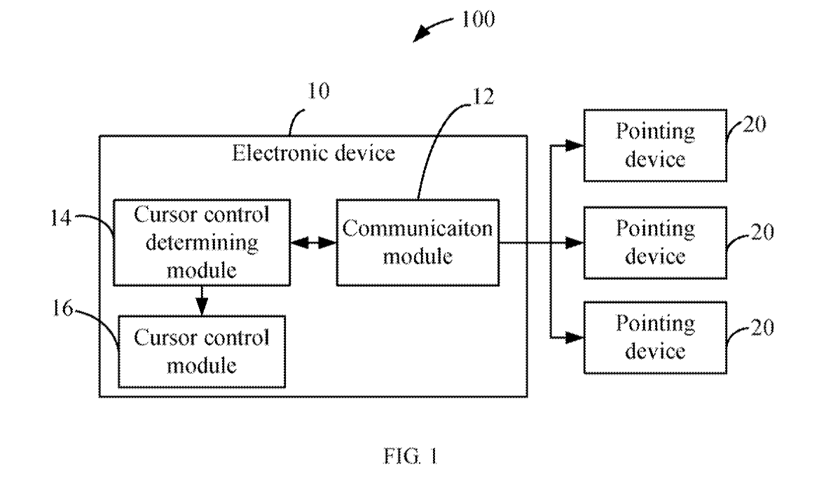

Referring to FIG. 1, an embodiment of a cursor control system 100 is illustrated. The system 100 includes an electronic device 10 and a number of pointing devices 20 communicating with the electronic device 10. The electronic device 10 may be a computer. The pointing devices 20 may be mice, or handwriting pens. In this embodiment, the pointing devices 20 are wirelessly connected to the electronic device 10. Each pointing device 20 can transmit wireless signals containing an identification code for identifying itself to the electronic device 10. The pointing device 20 which currently owns the control to control a cursor (hereinafter, cursor control) can control movement of a cursor displayed on the electronic device 10. Each pointing device 20 includes a button (not shown) for generating a request signal for requesting the cursor control to control the displayed cursor in response to user input.

The electronic device 10 includes a communication module 12, a cursor control determining module 14, and a cursor control module 16. The communication module 12 communicates the electronic device 10 with the pointing devices 20. In this embodiment, the communication unit 12 may include any one or more of a BLUETOOTH module, an infrared module, and a WIFI module, for example.

The cursor control determining module 14 determines whether a signal received by the communication module 12 is a request signal. The cursor control determining module 14 further determines whether the duration of not receiving a cursor control signal from the pointing device 20 which currently owns the cursor control reaches a predetermined time interval after determining that a request signal is received. If the duration reaches the predetermined time interval, the cursor control determining module 14 determines the pointing device 20 which sends the request signal according to the identification code embedded in the request signal, and transfers the cursor control to the determined pointing device 20. Hence, the determined pointing device 20 can transmit a cursor control signal to control the movement of the displayed cursor. The cursor control determining module 14 does not transfer the cursor control to the pointing device 20 which sends the request signal if a cursor control signal from the pointing device 20 which currently owns the cursor control is received within the predetermined time interval.

The cursor control module 16 controls the movement of the displayed cursor according to a cursor control signal from the pointing device 20 which currently owns the cursor control. That is, if a cursor control signal is not from the pointing device 20 which currently owns the cursor control, the cursor control module 16 does not control the movement of the displayed cursor according to the cursor control signal.

With such configuration, only a cursor is displayed on the electronic device 10, and only one pointing device 20 can control the displayed cursor at any time, thus it is clear to multiple users who controls the pointing devices 20 to control the displayed cursor. Furthermore, the electronic device 10 does not allow the pointing device 20 which sends the cursor control to control the displayed cursor when a cursor control signal from the pointing device 20 which currently owns the cursor control is received within the predetermined time interval. Thus, operation of the pointing device 20 which currently owns the cursor control can not be suddenly interrupted.

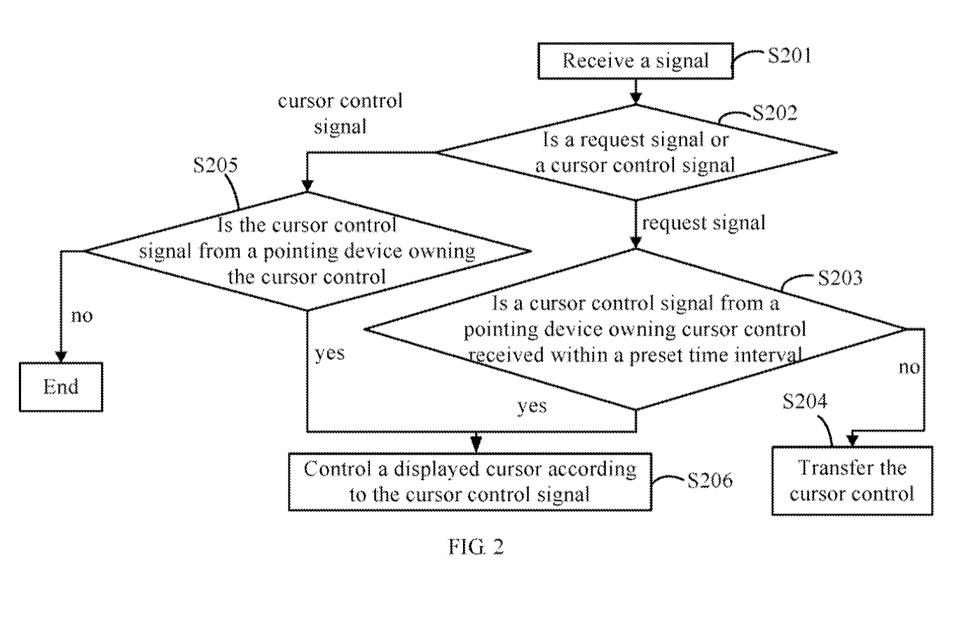

FIG. 2 is a flowchart of a cursor control method in accordance with an exemplary embodiment.

In step S201, the communication module 12 receives a signal.

In step S202, the cursor control determining module 14 determines whether the received signal is a request signal or a cursor control signal. If a request signal is received, step S203 is executed, otherwise, step S205 is executed.

In step S203, the cursor control determining module 14 determines whether the duration of not receiving a cursor control signal from the pointing device 20 which owns the cursor control reaches a predetermined time interval after determining that a request signal is received. If no, step S204 is executed, otherwise, step S206 is executed.

In step S204, the cursor control determining module 14 transfers the cursor control to the pointing device 20 which sends the request signal.

In step S205, the cursor control module 16 determines whether the cursor control signal is from the pointing device 20 which currently owns the cursor control. If yes, step S206 is executed, otherwise the procedure ends.

In step S206, the cursor control module 16 controls movement of the displayed cursor according to the cursor control signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A cursor control system, comprising:
an electronic device comprising:
a communication module to communicate the electronic device with a plurality of pointing devices each of which is capable of sending signals containing an identification code;
a cursor control determining module to determine whether a signal received from one of the plurality of pointing devices by the communication module is a request signal for requesting a control to control a displayed cursor, determine whether a duration of not receiving a cursor control signal from the pointing device which currently owns the control to control the displayed cursor reaches a predetermined time interval after determining that the request signal is received, and further determine the pointing device which sends the request signal according to the identification code embedded in the request signal and transfer the control to control the displayed cursor to the determined pointing device if the duration of not receiving a cursor control signal from the pointing device which currently owns the control to control the displayed cursor reaches the predetermined time interval; and
a cursor control module to control the displayed cursor according to a cursor control signal from the pointing device which currently owns the control to control the displayed cursor.

2. The cursor control system as described in claim 1, wherein the communication module is a wireless communication module.

3. The cursor control system as described in claim 2, wherein the communication module comprises at least one module selected from the group consisting of a BLUETOOTH module, an infrared module, and a WIFI module.

4. An electronic device comprising:
a communication module to communicate the electronic device with a plurality of pointing devices each of which is capable of sending signals containing an identification code;
a cursor control determining module to determine whether a signal received from one of the polarity of pointing devices by the communication module is a request signal for requesting the control to control a displayed cursor, determine whether a duration of not receiving a cursor control signal from the pointing device which currently owns the control to control the displayed cursor reaches a predetermined time interval after determining that the request signal is received, and further determine the pointing device which sends the request signal according to the identification code embedded in the request signal, and transfer the control to control the displayed cursor to the determined pointing device if the duration of not receiving a cursor control signal from the pointing device which currently owns the control to control the displayed cursor reaches the predetermined time interval; and
a cursor control module to control the displayed cursor according to a cursor control signal from the pointing device which currently owns the control to control the displayed cursor.

5. The electronic device as described in claim 1, wherein the communication module is a wireless communication module.

6. The electronic device as described in claim 5, wherein the communication module comprises at least one module selected from the group consisting of a BLUETOOTH module, an infrared module, and a WIFI module.

7. A cursor control method applied in an electronic device, the electronic device communicating with a plurality of pointing devices each of which is capable of transmitting signals containing an identification code, the cursor control method comprising:
receiving a signal from one of the pointing devices;
determining whether the received signal is a request signal for requesting the control to control a displayed cursor;
determining whether a duration of not receiving a cursor control signal from the pointing device which currently owns the control to control the displayed cursor reaches a predetermined time interval after determining that the request signal is received;
determining the pointing device which sends the request signal according to the identification code embedded in the request signal;
transferring the control to control the displayed cursor to the determined pointing device if the duration of not receiving a cursor control signal from the pointing device which currently owns the control to control the displayed cursor reaches the predetermined time interval; and
controlling movement of the displayed cursor according to a cursor control signal from the pointing device which currently owns the control to control the displayed cursor.

8. The cursor control method as described in claim 7, wherein the request signal and the cursor control signal are wireless signals.
